(19) United States
(12) Patent Application Publication
(10) Pub. No.: US 2025/0225509 A1
(43) Pub. Date: Jul. 10, 2025

(54) SYSTEMS AND METHODS FOR IDENTIFICATION-BASED PAYMENT INSTRUMENTS

(71) Applicant: Capital One Services, LLC, McLean, VA (US)

(72) Inventors: Kevin OSBORN, Newton Highlands, MA (US); Srinivasa CHIGURUPATI, Long Grove, IL (US); David Kelly WURMFELD, Melbourne, FL (US)

(21) Appl. No.: 18/408,780

(22) Filed: Jan. 10, 2024

(51) Int. Cl. G06Q 20/38; H04L 9/08; H04L 9/32

(52) U.S. Cl. CPC G06Q 20/3823; H04L 9/0825; H04L 9/3247; H04L 9/3263

(57) ABSTRACT

Systems and methods of identification-based payment instruments is provided. An exemplary system includes a computer server including a memory and a processor. The server is configured to receive at least one digital certificate as an universal identification of a user, associate the at least one digital certificate with at least one payment instrument of the user, generate a public key and a private key pairing with the public key, the public key and the private key being associated with the at least one payment instrument, incorporate the public key into the digital certificate, and transmit the private key to a user device associated with the user.

### FIELD OF THE INVENTION

The present disclosure relates generally to payment instrument, and more particularly, to systems and methods for identification-based payment instruments.

### BACKGROUND

Payment instruments, and the systems of record and business processes associated with payment instruments, are often controlled by different entities. This can be true even when the payment instruments are controlled by the same entity. For example, various payment instruments, such as credit cards, are often disconnected, and it is difficult to perform transactions and/or move money between them without user and customer service engagement.

These and other deficiencies exist. Accordingly, there is a need to provide systems and methods that overcome these deficiencies to unify payment instruments and account interactions.

### SUMMARY

Aspects of the disclosed technology include systems and methods of identification-based payment instruments.

Embodiments of the present disclosure provide a system of identification-based payment instruments is provided. The system includes a computer server including a memory and a processor. The server is configured to: receive at least one digital certificate as an universal identification of a user; associate the at least one digital certificate with at least one payment instrument of the user; generate a public key and a private key pairing with the public key, the public key and the private key being associated with the at least one payment instrument; incorporate the public key into the digital certificate; and transmit the private key to a user device associated with the user.

Embodiments of the present disclosure provide a method of managing universal identification-based payment instruments. The method includes: receiving at least one digital certificate as an universal identification) of a user; associating the at least one digital certificate with at least one payment instrument of the user; generating a public key and a private key pairing with the public key, the public key and the private key being associated with the at least one payment instrument; incorporating the public key into the digital certificate; and transmitting the private key to a user device associated with the user.

Embodiments of the present disclosure provide a non-transitory, computer-readable medium comprising instructions for managing universal identification-based payment instruments that, when executed on a computer arrangement, perform actions comprising: receiving at least one digital certificate as an universal identification of a user; associating the at least one digital certificate with at least one payment instrument of the user; generating a public key and a private key pairing with the public key, the public key and the private key being associated with the at least one payment instrument; incorporating the public key into the digital certificate; and transmitting the private key to a user device associated with the user.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

FIG. 1 is a diagram of a system of identification-based payment instruments according to an example embodiment.

FIG. 2 is a diagram of sequential interactions between components of the system in FIG. 1 according to an example embodiment.

FIG. 3 is a flow chart of a method using identification-based payment instruments according to an example embodiment.

FIG. 4 is a flow chart of a method using identification-based payment instruments according to an example embodiment.

FIG. 5 is a flow chart of a method using identification-based payment instruments according to an example embodiment.

FIG. 6 is a flow chart of a method using identification-based payment instruments according to an example embodiment.

### DETAILED DESCRIPTION OF EXAMPLE EMBODIMENTS

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The described features and teachings of the embodiments may be combined in any suitable manner. A person of ordinary skill in the art will recognize that the embodiments may be practiced without one or more of the specific features and teachings of an embodiment. In other instances, additional features and teachings may be recognized in certain embodiments that may not be present in all embodiments. A person of ordinary skill in the art will understand that the described features and teachings of any embodiment can be interchangeably combined with the features and teachings of any other embodiment.

As described above, payment instruments, and the systems of record and business processes associated with payment instruments, are often controlled by different entities. The present disclosure provides a systems and methods of identification-based payment instruments that can identify account owners through a universal identification, and can apply digital attestations for proof of ownership of the identification-based payment instruments.

Different entities can employ a record of a user's digital identity as a universal identification that can be stored in either a centralized system and/or a decentralized system (e.g., a blockchain). This record can attach multiple account references along with references to their individual system of record and/or validation application programming interface (API) systems. The multiple accounts can be associated with multiple payment instruments. The digital identity also references a number of public keys for validating the ownership of the multiple accounts and/or multiple payment instruments. Through a chain of trust, one payment instrument can be “converted as proof of co-ownership” through the validated “notarized” record of the list of payment instruments. If the user's digital identity as a universal identification is stored in a decentralized system, systems and methods of the present disclosure can also be applied across different entities.

In some embodiments, the disclosed systems and methods can be used for payment transactions retroactively. For example, if a user used a wrong credit card for a transaction, a different payment instrument can then be proposed to transfer the transaction, by refunding and resubmitting the transaction on behalf of the new payment instrument.

In some embodiments, the disclosed systems and methods can utilize virtual payment instruments for authorizing transactions, with authentication accomplished by a notification to the user to perform a series of digital signatures on a reconciliation order which contains references to the transactions including their respective signed payment instruments.

The present disclosure can provide a standard way of unifying payment instruments and account interactivities, so as to overcome the deficiencies with various payment instruments that are disconnected, including without limitation, that it is difficult to perform transactions and/or move money between them without user and customer service engagement, which can reduce transaction efficiency, diminish the user experience, and reduce the demand for users to conduct transactions. The present disclosure can provide an efficient process flow between payment instruments, for example opening and/or managing accounts, printing checks (e.g., for a business payroll), instant card issuance (e.g., for card replacement), and ad hoc personal account check printing.

The disclosed systems and methods can use the public key cryptography to attest a universal identity of a user, and then use digital signatures of the user to prove ownership of the payment instrument in a transaction. For example, the user can be issued a public key and a private key by, e.g., a bank, because the bank has already performed a know-your-customer (KYC) procedure to confirm the identity of the user. Thereafter, when the user gets a new payment instrument (e.g., a credit card) from the bank or other financial institutions, the user can sign a random data (e.g., a nonce, a series of digital numbers, or a phrase, etc.) using the private key and place the public key along with the signature on the new payment instrument. The new payment instrument itself can be used to validate against that universal identity. The present disclosure can also create a synthetic payment instrument that chains other payment instruments together. In addition to being similar in some respects to a virtual card number (VCN) method, the present disclosure can verify the universal identity and the ownership of those various payment instruments associated with the synthetic payment instrument, such that a transaction can be split across those different payment instruments.

The universal identity can be a public key certificate of the user that is digitally signed by an authority such as a notary, a bank, a government agency, a department of motor vehicle, etc., When the public key certificate is used to validate whether or not a payment instrument is trusted, one or more of the authority's digital signatures can be used depending which authority the merchant or payment processor trusts more. The user can sign a challenge or the like using the private key, and then pass the public key certificate along to the payment processor. And the payment processor can evaluate those different trust chains, and determine which matters most to them to validate the ownership of payment instrument involved in the transaction.

In addition to splitting charges among different payment instruments, the present disclosure can also allow for the transfer of a charge from one payment instrument to another payment instrument. For example, a first user can pay for a transaction using a first payment instrument, and a second user can request to transfer an entirety or part of the already performed transaction to a second payment instrument associated with the second user, the second user can use his private key to digitally sign a random data such as a random challenge phrase that goes into that invoice associated with the already made transaction, and pass along his or her public key certificate as his universal identity to the payment processor. The payment processor can validate the second user's permission and the ownership of the second payment instrument based on the digital signature and the public key certificate of the second user, so the payment processor can then perform the charge transfer to the second payment instrument.

In a case where the payment instrument is a contactless card, the present disclosure can also allow the contact card to digitally sign a transaction invoice for charge transfer. For example, a user's mobile phone may receive a transaction invoice requesting a charge transfer, and the user is asked to tap the contactless card to the mobile phone. Upon taping the contactless card, the contactless card may transmit a charge permission request to the mobile device, and then the mobile device can transmit to the contactless card a token that represents approving the permission. The contactless card can digitally sign the token using the private key stored on the contactless card and then attached the signed token to the invoice. That invoice can be transmitted to the transaction processing for transferring the charge to the contactless card. Alternatively, the mobile device can digitally sign the invoice for permitting the charge transfer if the mobile device can have the private key stored on itself and can perform multi-factor authentication.

The present disclosure can use a VCN to split a transaction between two or more payment cards. The VCN can be tied to the two or more payment cards. For example, a first charge on the transaction can be charged to a first payment card tied to the VCN, a second charge on the transaction can be charged to a second payment card tied to the VCN, etc. In this case, the transaction can be digitally signed by the respective payment card owners for validation of ownership and charge permission.

The universal identities, the public keys, and their associated digital signatures can be stored in a centralized matter, such as by a single bank or a bank consortium etc. In some embodiments, the universal identities, the public keys, and their associated digital signatures can be stored in a decentralized manner, such as in a public blockchain. However, the private keys associated with payment instruments are not stored on the blockchain, those are held by the payment instrument owners themselves. With a decentralized manner, multiple banks can participate in the disclosed system but still trust the information, because they are able to retrieve them from the public blockchain.

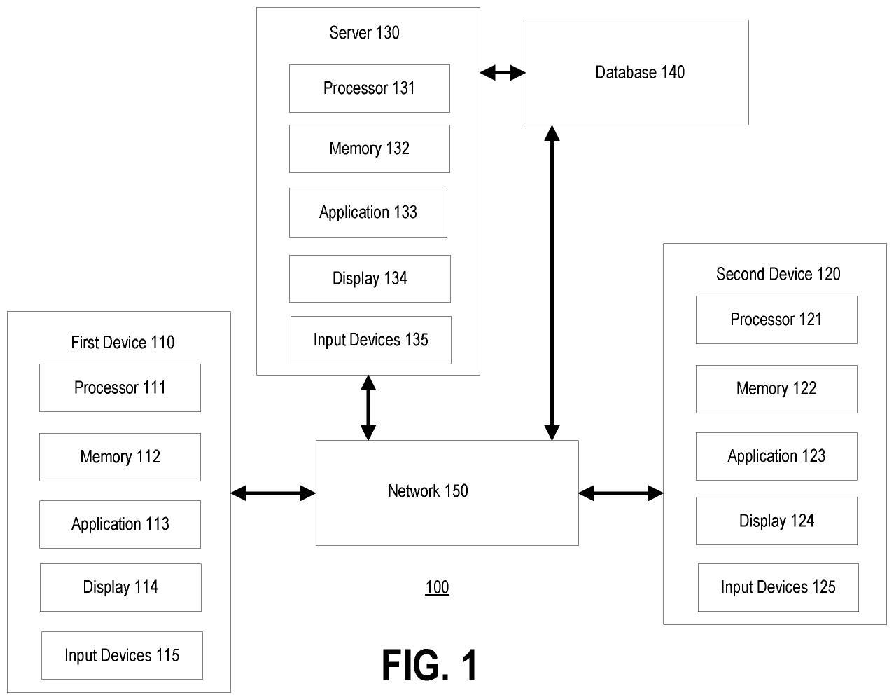

FIG. 1 illustrates a system 100 of identification-based payment instruments according to an example embodiment. As further discussed below, the system 100 may include a first device 110, a second device 120, a server 130, and a database 140 in communication using a network 150. Although FIG. 1 illustrates single instances of the components, the system 100 may include any number of components.

The first device 110 may be associated with a user, for example, a mobile phone of the user on which the user can perform transactions.

The first device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The first device 110 may include a processor 111, a memory 112, and an application 113. The processor 111 may be a processor, a microprocessor, or other processor, and the first device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the first device 110 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's financial account information.

The application 113 may comprise one or more software applications comprising instructions for execution on the first device 110. In some examples, the first device 110 may execute one or more applications, such as software applications, that enable, for example, network communications with one or more components of the system 100, transmit and/or receive data, and perform the functions described herein. Upon execution by the processor 111, the application 113 may provide the functions described in this specification, specifically to execute and perform the steps and functions in the process flows described herein. For example, the application 113 may be executed to perform authenticating the user or send an authentication request of authenticating the user. The application 113 may also be executed to perform processing transactions of a user. Such processes may be implemented in software, such as software modules, for execution by computers or other machines. The application 113 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The first device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the first device 110 that is available and supported by the first device 110, such as a touch-screen, keyboard, mouse, cursor-control device, microphone, digital camera, video recorder or camcorder. These devices may be used to enter information and interact with the software and other devices described herein.

The second device 120 can be associated with financial institutions such as banks. The banks can issue various payment instruments to the user.

The second device 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The second device 120 may include a processor 121, a memory 122, an application 123, a display 124, and input devices 125. The processor 121 may be a processor, a microprocessor, or other processor, and the second device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the second device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as private and personal information.

The application 123 may comprise one or more software applications comprising instructions for execution on the second device 120. In some examples, the second device 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described herein. Such processes may be implemented in software, such as software modules, for execution by computers or other machines. The application 123 may provide graphic user interfaces (GUIs) through which users may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The second device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the second device 120 that is available and supported by the second device 120, such as a touch-screen, keyboard, mouse, cursor-control device, microphone, digital camera, video recorder or camcorder. These devices may be used to enter information and interact with the software and other devices described herein such as selecting an option of creating an online account with the merchant.

The server 130 may be associated with a financial institution, and can be configured to communicate with the first device 110 and/or the second device 120.

The server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's financial account information and the contactless card information.

The application 133 may comprise one or more software applications comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described herein. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that is available and supported by the server 130, such as a touch-screen, keyboard, mouse, cursor-control device, microphone, digital camera, video recorder or camcorder. These devices may be used to enter information and interact with the software and other devices described herein.

The database 140 may be one or more databases configured to store date, including without limitation, private information of users, financial accounts of users, and transactions of users. The database 140 may comprise a relational database, a non-relational database, or other database implementations, and any combination thereof, including a plurality of relational databases and non-relational databases. In some examples, the database 140 may comprise a desktop database, a mobile database, or an in-memory database. Further, the database 140 may be hosted internally by the server 130 or may be hosted externally of the server 130, such as by a server, by a cloud-based platform, or in any storage device that is in data communication with the server 130.

The system 100 may include one or more networks 150. In some examples, the network 150 may be one or more of a wireless network, a wired network or any combination of wireless network and wired network, and may be configured to connect the first device 110, the second device 120, the server 130, and the database 140. For example, the network 150 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 150 may include, without limitation, telephone lines, fiber optics, IEEE Ethernet 902.3, a wide area network, a wireless personal area network, a LAN, or a global network such as the Internet. In addition, the network 150 may support an Internet network, a wireless communication network, a cellular network, or the like, or any combination thereof. The network 150 may further include one network, or any number of the exemplary types of networks mentioned above, operating as a stand-alone network or in cooperation with each other. The network 150 may utilize one or more protocols of one or more network elements to which they are communicatively coupled. The network 150 may translate to or from other protocols to one or more protocols of network devices. Although the network 150 is depicted as a single network, it should be appreciated that according to one or more examples, the network 150 may comprise a plurality of interconnected networks, such as, for example, the Internet, a service provider's network, a cable television network, corporate networks, such as credit card association networks, and home networks. The network 150 may further comprise, or be configured to create, one or more front channels, which may be publicly accessible and through which communications may be observable, and one or more secured back channels, which may not be publicly accessible and through which communications may not be observable.

In some examples, communications between the first device 110, server 130, and second device 120 using the network 150 can occur using one or more front channels and one or more secure back channels. A front channel may be a communication protocol that employs a publicly accessible and/or unsecured communication channel such that a communication sent to the first device 110, server 130, and/or second device 120 may originate from any other device, whether known or unknown to the first device 110, server 130, and/or second device 120, if that device possesses the address (e.g., network address, Internet Protocol (IP) address) of the first device 110, server 130, and/or second device 120. Exemplary front channels include, without limitation, the Internet, an open network, and other publicly-accessible communication networks. In some examples, communications sent using a front channel may be subject to unauthorized observation by another device. In some examples, front channel communications may comprise Hypertext Transfer Protocol (HTTP) secure socket layer (SSL) communications, HTTP Secure (HTTPS) communications, and browser-based communications with a server or other device.

A secure back channel may be a communication protocol that employs a secured and/or publicly inaccessible communication channel. A secure back channel communication sent to the first device 110, server 130, and/or second device 120 may not originate from any device, and instead may only originate from a selective number of parties. In some examples, the selective number of devices may comprise known, trusted, or otherwise previously authorized devices. Exemplary secure back channels include, without limitation, a closed network, a private network, a virtual private network, an offline private network, and other private communication networks. In some examples, communications sent using a secure back channel may not be subject to unauthorized observation by another device. In some examples, secure back channel communications may comprise Hypertext Transfer Protocol (HTTP) secure socket layer (SSL) communications, HTTP Secure (HTTPS) communications, and browser-based communications with a server or other device.

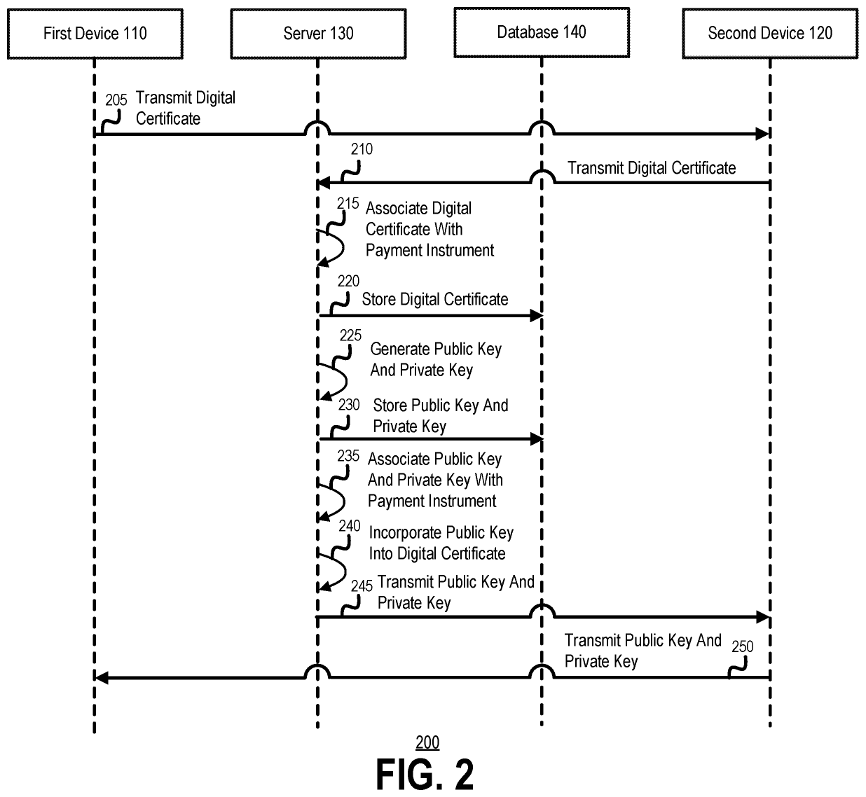

FIG. 2 illustrates an example diagram 200 of sequence interaction between the components of the system 100 according to an example embodiment. FIG. 2 may reference the same or similar components as those illustrated in FIG. 1, including a first device, a server, a database, and a second device.

A digital certificate of a user can be used as a universal identification of the user. The digital certificate may be digitally signed by an authority. The authority can be a notary, a bank, a government agency (e.g., a Department of Motor Vehicles), etc., The digital certificate may include an identity of the user and a digital signature of the authority. The digital certificate may be stored on a user device of the user, such as the first device 110. At step 205, the first device 110 may transmit the digital certificate to the second device 120 associated with a bank who issues payment instruments to the user.

At step 210, the second device 120 may transmit the digital certificate to the server 130. The digital certificate may further include a public key of the authority. The digital signature of the authority is generated using a private key of the authority pairing with the public key of the authority.

At step 215, the server 130 may associate the digital certificate with one or more payment instruments of the user. In some embodiment, each of the one or more payment instruments may be associated with a different digital certificate. In some embodiments, all of the one or more payment instruments may be associated with a same digital certificate. At step 220, the server 130 may store the digital certificate in the database 140.

At step 225, the server 130 may generate a public key and a private key pairing with the public key. In some embodiments, the server 130 may generate a different public and private key for each of the one or more payment instruments. In some embodiments, the server 130 may generate a same public and private key for all of the one or more payment instruments.

At step 230, the server 130 may store the public key and the private key on the database 140.

At step 235, the server 130 may associate the public key and the private key with the one or more payment instruments.

At step 240, the server 130 may incorporate the public key of the one or more payment instruments into the digital certificate. Thus, at this time, the digital certificate may further include the public key of the one or more payment instruments.

At step 245, the server 130 may transmit the public key and the private key of the one or more payment instruments to the second device 120.

At step 250, the second device 120 may transmit the public key and the private key of the one or more payment instruments to the first device 110. The user can use the private key of the one or more payment instruments to create a digital signature that can be attached to an transaction for validating his or her ownership of the one or more payment instruments.

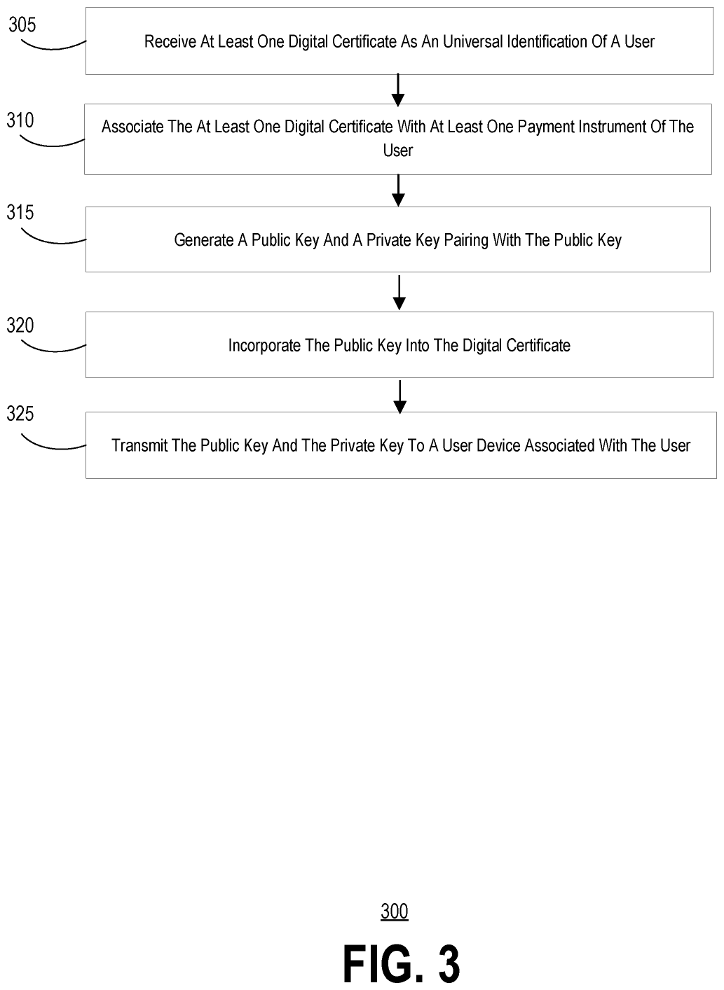

FIG. 3 illustrates a flow chart of an example method 300 using identification-based payment instruments according to an example embodiment. FIG. 3 may reference the same or similar components as those illustrated in FIGS. 1 and 2, including a first device, a server, a database, and a second device. The method 300 can be implemented in the system 100 and may include, but is not limited to the following steps.

At step 305, the server 130 may receive, from a first device 110, at least one digital certificate as an universal identification of a user. The digital certificate may be digitally signed by an authority. The authority can be a notary, a bank, a government agency (e.g., a Department of Motor Vehicles), etc. The digital certificate may include an identity of the user and a digital signature of the authority. The digital certificate may further include a public key of the authority. The digital signature of the authority is generated using a private key of the authority pairing with the public key of the authority.

At step 310, the server 130 may associate the at least one digital certificate with at least one payment instrument of the user. Each of the at least one payment instrument may be associated with a different digital certificate. Alternatively, the at least one payment instrument may be associated with a same digital certificate.

At step 315, the server 130 may generate a public key and a private key pairing with the public key, and associate the public key and the private key with the at least one payment instrument. Each of the at least one payment instrument may be associated with a different public and private key. In some embodiments, a same public and private key may be associated with the at least one payment instrument.

At step 320, the server 130 may incorporate the public key associated with the at least one payment instrument into the digital certificate. After incorporating the public key associated with the at least one payment instrument, the digital certificate may further include the public key associated with the at least one payment instrument, which may be referred to as a public key digital certificate of the at least one payment instrument. This public key digital certificate can be used as a universal identification of the user to validate the ownership of the at least one payment instrument issued to the user.

At step 325, the server 130 may transmit the public key and the private key of the at least one payment instrument to a user device associated with the user (e.g., the first device 110). The user can store the public key and the private key of the at least one payment instrument on the user device. The user device can use the private key of the at least one payment instrument to create a digital signature that can be attached to an transaction for validating his or her ownership of the at least one payment instrument.

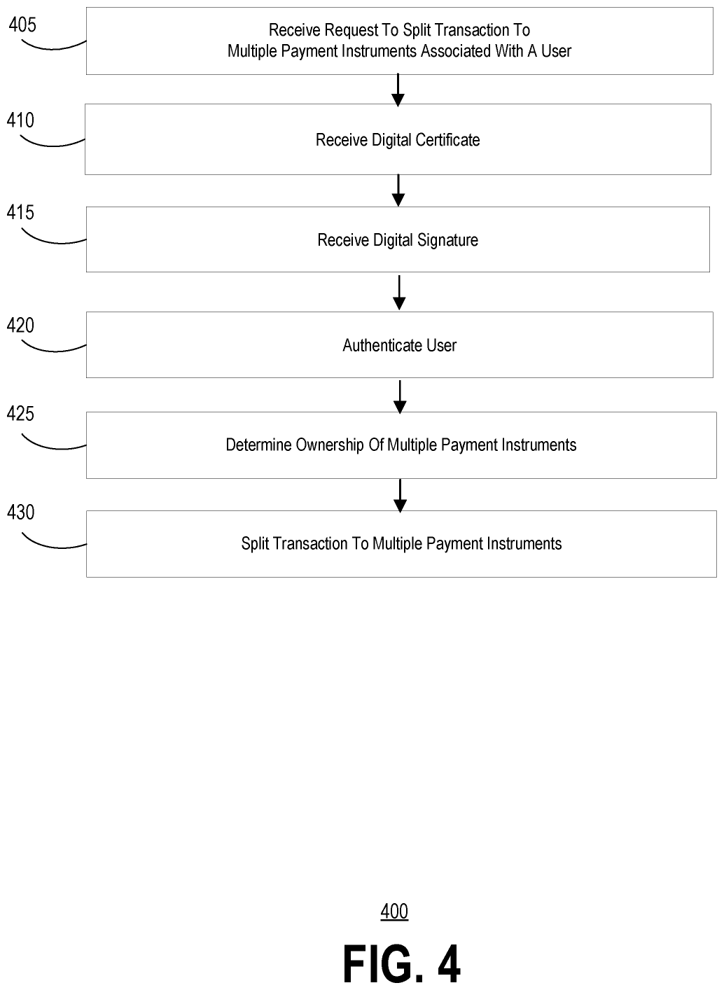

FIG. 4 illustrates a flow chart of an example method 400 using identification-based payment instruments according to an example embodiment. FIG. 4 may reference the same or similar components as those illustrated in FIGS. 1-3, including a first device, a server, a database, and a second device. The method 400 can be implemented in the system 100 and may include, but is not limited to the following steps.

At step 405, the server 130 may receive a request for splitting a transaction to multiple payment instruments associated with a user. This user can have the multiple payment instruments that may be issued by the same entity or different entities. When the user wants to split the transaction to the multiple payment instruments, the user may transmit via the first device 110 to the server 130 a request of split the transaction to the multiple payment instruments, along with a receipt or invoice of the transaction.

At step 410, the server 130 may receive a digital certificate of the user from the first device 110. The digital certificate of the user can be used as a universal identification for the user to be associated with the multiple payment instruments. The digital certificate may include an identity of the user and a digital signature of an authority who digitally signed the digital certificate. The digital certificate may further include a public key of the authority. The digital signature of the authority is generated using a private key of the authority pairing with the public key of the authority. The digital certificate may further include at least one public key associated with the user and/or the multiple payment instruments. If the multiple payment instruments are issued by a same bank, one public key and one private key pairing the one public key may be issued to the user by the same bank, so the digital certificate can include one public key associated with the user and/or the multiple payment instruments. If the multiple payment instruments are issued by different banks, different public keys and different private keys pairing the different public keys may be issued to the user by the different banks with respect to the multiple payment instruments, so the digital certificate can include different public keys of the user corresponding to the multiple payment instruments and/or the different banks. The user can transmit via the first device 110 the digital certificate to the server 130. Alternatively, the server 130 may retrieve the digital certificate from a centralized or decentralized storage location by following an instruction message included in the transaction splitting request.

At step 415, the server 130 may receive at least one digital signature of the user from the first device 110. As described above, if the multiple payment instruments are issued by a same bank, one public key and one private key pairing the one public key may be issued to the user by the same bank to be associated with the multiple payment instruments, and one digital signature of the user generated using the one private key can be received by the server 130 from the first device 110. If the multiple payment instruments are issued by different banks, different public keys and different private keys pairing the different public keys may be issued to the user by the different banks to be associated with the multiple payment instruments, multiple digital signatures of the user generated using the different private keys can be received by the server 130 from the first device 110, where the multiple digital signatures of the user correspond to the multiple payment instruments and/or the different banks.

At step 420, the server 130 may authenticate the user based on the at least one digital signature of the user and the digital certificate. For example, the server 130 may first communicate with the authority issuing the digital certificate to verify the authenticity of the digital certificate. The server 130 may also verify the digital certificate by decrypting the digital signature of the authority using the public key of the authority that are included on the digital certificate. The server 130 may authenticate the user by further decrypting the at least one digital signature of the user using the corresponding public key of the user that are included on the digital certificate.

At step 425, the server 130 may determine ownership of the multiple payment instruments. Based on the authentication of the user, the server 130 can determine the ownership of the multiple payment instruments. The ownership of the multiple payment instruments by the user can indicate that the transaction splitting request by the user is legitimate.

At step 430, the server 130 may split the transaction to the multiple payment instruments. For example, according to the transaction splitting request, a first part of the transaction may be charged to a first payment instrument of the multiple payment instruments, a second part of the transaction may be charged to a second payment instrument of the multiple payment instruments, and etc., The server 130 itself may perform splitting the transaction, or may transmit to a dedicated transaction processor for splitting the transaction.

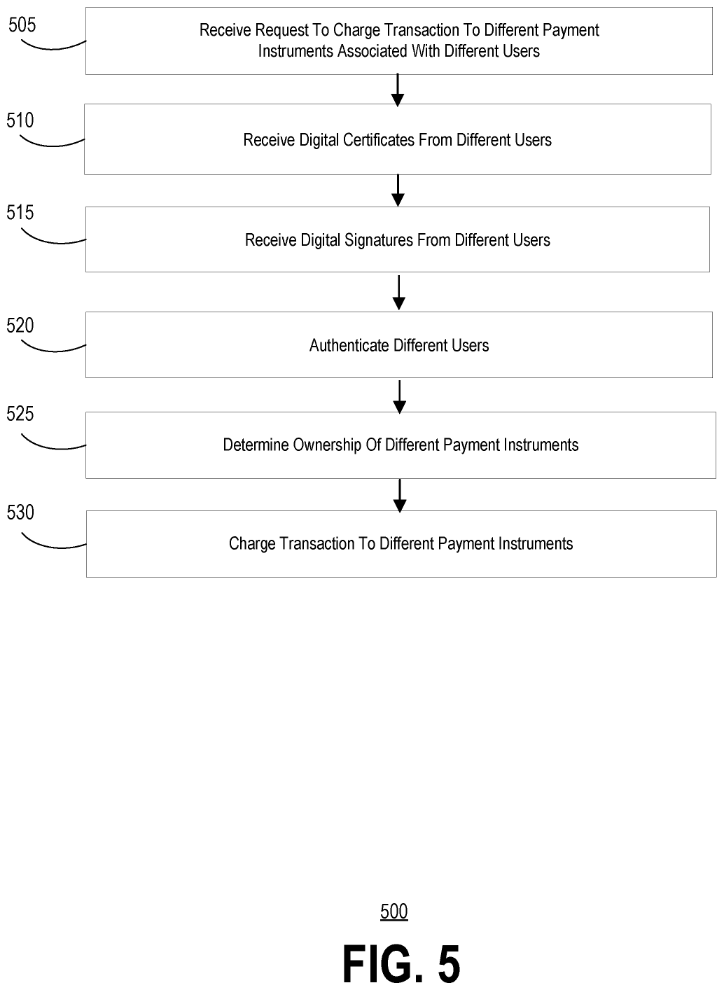

FIG. 5 illustrates a flow chart of an example method 500 using identification-based payment instrument according to an example embodiment. FIG. 5 may reference the same or similar components as those illustrated in FIGS. 1-4, including a first device, a server, a database, and a second device. The method 500 can be implemented in the system 100 and may include, but is not limited to the following steps.

In some situations, a transaction needs to be split among different payment instruments associated with different users. For example, one of a group of users may use his or her credit card to pay the full bill for the group of users at a restaurant, then may request to split the bill among different credit cards associated with corresponding users of the group. At step 505, the server 130 may receive a request of charge a transaction/bill to different payment instruments associated with different users. For example, a user who has paid the bill fully may transmit the request to the server 130 asking for refund from other users. The different payment instruments may be issued by a same bank or different banks. When the user may transmit via the first device 110 to the server 130 the request along with a receipt or invoice of the transaction.

At step 510, the server 130 may receive from the different users their corresponding digital certificates. The server 130 may transmit the receipt of the transaction to the different users asking for digital certificates/digital signatures of the different users. Alternatively, the user who paid the bill fully may transmit the receipt of the transaction to other users. The other users may each then transmit to the server 130 their corresponding digital certificates/digital signatures attached to the receipt.

At step 515, the server 130 may receive from the different users their corresponding digital signatures. Each of the digital signatures is generated by the corresponding user using their corresponding private keys associated with their corresponding payment instruments and issued by their corresponding banks. Each of the digital signatures can be signed on the receipt that is received by the different users, and returned to the server 130.

At step 520, the server 130 may authenticate the different users based on their corresponding digital signatures and digital certificates. For example, the server 130 may first communicate with the corresponding authorities issuing the corresponding digital certificates to verify the authenticity of the corresponding digital certificates. The server 130 may also verify the digital certificates by decrypting the digital signatures of the corresponding authorities using the public keys of the corresponding authorities that are included on the corresponding digital certificates. The server 130 may authenticate the different users by further decrypting the corresponding digital signatures using the corresponding public keys of that are included on the corresponding digital certificates.

At step 525, the server 130 may determine ownership of the different payment instruments. Based on the authentication of the different users, the server 130 can determine the ownership of the different payment instruments. The ownership of the different payment instruments by the different users can indicate that the transaction splitting request by the user who paid the full bill is legitimate.

At step 530, the server 130 may charge the transaction to the different payment instruments. For example, according to the transaction splitting request, a first part of the transaction may be charged to a first payment instrument associated with a first user, a second part of the transaction may be charged to a second payment instrument associated with a second user, and etc., The server 130 itself may perform splitting the transaction, or may transmit to a dedicated transaction processor for splitting the transaction.

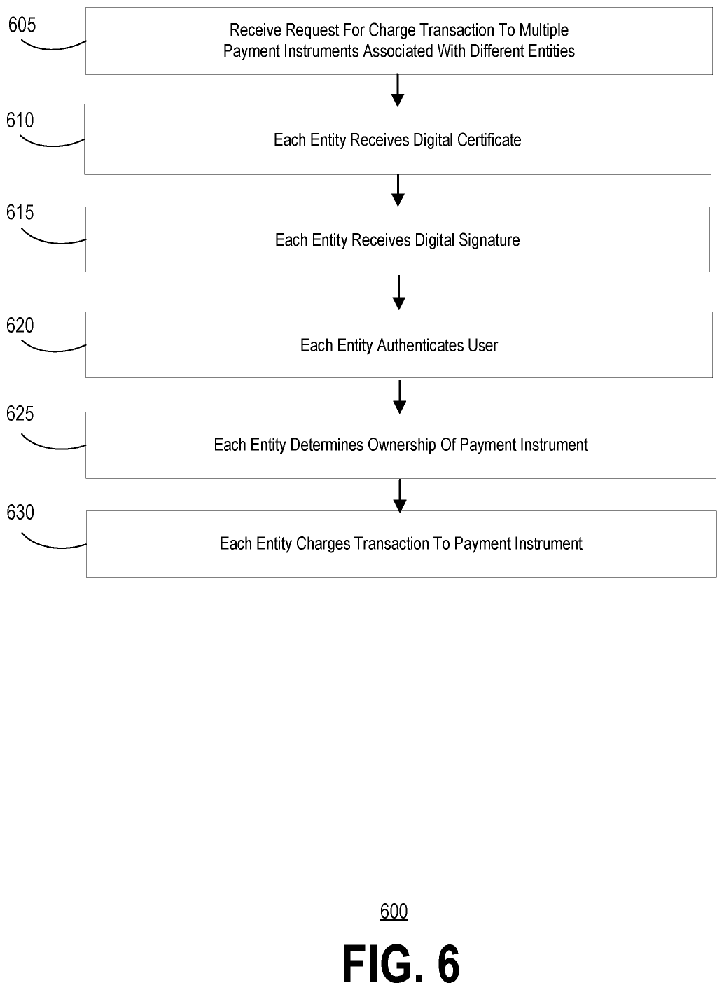

FIG. 6 illustrates a flow chart of an example method 600 using identification-based payment instruments according to an example embodiment. FIG. 6 may reference the same or similar components as those illustrated in FIGS. 1-5, including a first device, a server, a database, and a second device. The method 600 can be implemented in the system 100 and may include, but is not limited to the following steps.

In some situations, a transaction may need to be split among different payment instruments associated with different entities (such as banks). At step 605, the server 130 may receive a request for splitting a transaction to multiple different payment instruments associated with different entities. The request can be initiated by an owner of any of the multiple different payment instruments. The request may include a receipt of the transaction, and information of the multiple different payment instruments such as payment instrument account numbers and owners, issuers of the payment instruments, etc.

The server 130 may transmit the request to each of the entities such as the issuing banks of the multiple different payment instruments. At step 610, each entity may receive a digital certificate corresponding the payment instrument issued by that entity, for example, by requesting the digital certificate from the corresponding owner of that payment instrument or retrieving the digital certificate from a centralized or decentralized storage location. The digital certificate of the corresponding owner can include a public key associated with the corresponding owner and issued by that entity.

At step 615, each entity may receive a digital signature of the corresponding owner of that payment instrument. The digital signature of the corresponding owner can be created by the corresponding owner using a private key associated with that payment instrument and issued by that entity. The digital signature of the corresponding owner may be included in the transaction splitting request or may be directly received from the corresponding owner.

At step 620, each entity may authenticate the corresponding owner/user based on the digital signature of the corresponding owner and the digital certificate corresponding the payment instrument, as described above

At step 625, each entity may determine the ownership of the corresponding payment instrument. Based on the authentication of the corresponding owner, that entity can determine the ownership of the corresponding payment instrument. The ownership of the corresponding payment instrument by the corresponding owner can indicate that the transaction splitting request is legitimate.

At step 630, each entity may charge a corresponding portion of the transaction to the corresponding payment instrument. For example, according to the transaction splitting request, a first part of the transaction may be charged to a first payment instrument associated with a first entity, a second part of the transaction may be charged to a second payment instrument associated with a second entity, and etc., Each entity itself performs charging the corresponding portion of the transaction to the corresponding payment instrument issued by that entity.

In some aspects, the techniques described herein relate to a system of identification-based payment instruments, including a computer server including a memory and a processor, wherein the server is configured to: receive at least one digital certificate as an universal identification of a user; associate the at least one digital certificate with at least one payment instrument of the user; generate a public key and a private key pairing with the public key, the public key and the private key being associated with the at least one payment instrument; incorporate the public key into the digital certificate; and transmit the private key to a user device associated with the user.

In some aspects, the techniques described herein relate to a system, wherein the at least one digital certificate is digitally signed using a digital signature by a notary.

In some aspects, the techniques described herein relate to a system, wherein the at least one digital certificate includes a further public key associated with the notary.

In some aspects, the techniques described herein relate to a system, wherein the computer server is configured to store the at least one digital certificate in a centralized computer database.

In some aspects, the techniques described herein relate to a system, wherein the computer server is configured to receive a transaction request digitally signed using a digital signature, the transaction request being associated with the at least one payment instrument, the transaction request including the at least one digital certificate, and the digital signature being generated by the user using the private key associated with the at least one payment instrument.

In some aspects, the techniques described herein relate to a system, wherein the computer server is configured to verify the at least one digital certificate included in the transaction request; authenticate the user by decrypting the digital signature using the public key associated with the at least one payment instrument; and determine an ownership of the at least one payment instrument to be the user.

In some aspects, the techniques described herein relate to a system, wherein verify the at least one digital certificate included in the transaction request includes decrypting a further digital signature signing the digital certificate by a further public key of an authority issuing the digital certificate, the further digital signature signing the digital certificate being generated using a private key of the authority issuing the digital certificate.

In some aspects, the techniques described herein relate to a system, wherein the at least one payment instrument include a plurality of payment instruments administered by one entity.

In some aspects, the techniques described herein relate to a system, wherein the at least one digital certificate include a plurality of digital certificates signed by different authorities.

In some aspects, the techniques described herein relate to a system, wherein the at least one payment instrument is a virtual payment instrument.

In some aspects, the techniques described herein relate to a system, wherein the computer server is further configured to store on the at least one payment instrument the public key associated with the at least one payment instrument and a digital signature generated using the private key associated with the at least one payment instrument.

In some aspects, the techniques described herein relate to a method of managing universal identification-based payment instruments, including: receiving at least one digital certificate as an universal identification) of a user; associating the at least one digital certificate with at least one payment instrument of the user; generating a public key and a private key pairing with the public key, the public key and the private key being associated with the at least one payment instrument; incorporating the public key into the digital certificate; and transmitting the private key to a user device associated with the user.

In some aspects, the techniques described herein relate to a method, wherein the at least one digital certificate is digitally signed using a digital signature by a financial institution.

In some aspects, the techniques described herein relate to a method, wherein the at least one digital certificate includes a further public key associated with the financial institution and used to verify the digital signature.

In some aspects, the techniques described herein relate to a method, further including storing the at least one digital certificate in a decentralized computer database.

In some aspects, the techniques described herein relate to a method, wherein the at least one digital certificate is digitally signed using a digital signature by a department of vehicle.

In some aspects, the techniques described herein relate to a method, wherein the at least one digital certificate includes a further public key (e.g., associated with the department of vehicle) used to verify the digital signature.

In some aspects, the techniques described herein relate to a method, wherein the at least one digital certificate is digitally signed using a digital signature by a notary.

In some aspects, the techniques described herein relate to a method, wherein the at least one digital certificate includes a further public key associated with the notary and used to verify the digital signature.

In some aspects, the techniques described herein relate to a non-transitory, computer-readable medium including instructions for managing universal identification-based payment instruments that, when executed on a computer arrangement, perform actions including: receiving at least one digital certificate as an universal identification of a user; associating the at least one digital certificate with at least one payment instrument of the user; generating a public key and a private key pairing with the public key, the public key and the private key being associated with the at least one payment instrument; incorporating the public key into the digital certificate; and transmitting the private key to a user device associated with the user.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

As used herein, the term “transaction” can include, without limitation, financial transactions. However, it is understood that the term “transaction” is not limited thereto, and the present disclosure can include financial transactions, identity verification transactions, area access transactions, user authentication transactions, membership verification transactions, eligibility verification transactions, and any other operation involving a card.

In some examples, the present disclosure refers to a transaction involving a merchant or vendor, which may include, without limitation, retail merchants and vendors. However, it is understood that the term “merchant” is not limited thereto, and the present disclosure can include any type of merchant, vendor, or other entity involving in activities where products or services are sold or otherwise provided, either online, in a physical location, or both.

As used herein, the terms “entity” and “institution” can include, without limitation, financial institutions (e.g., a bank). However, it is understood that the terms “entity” and “institution” are not limited thereto, and the present disclosure can include individuals, corporations, state, local, and federal governments, and any other entity involved in transactions.

In some examples, exemplary procedures in accordance with the present disclosure described herein can be performed by a processing arrangement and/or a computer arrangement (e.g., a computer hardware arrangement). Such processing and/or computer arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of a first device, a user device, a server, or other computer hardware arrangement. The computer arrangement herein can be the first device 110, the second device 120, and/or the server 130 in the system 100 of FIG. 1.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system of identification-based payment instruments, comprising a computer server including a memory and a processor, wherein the server is configured to:
receive at least one digital certificate as an universal identification of a user;
associate the at least one digital certificate with at least one payment instrument of the user;
generate a public key and a private key pairing with the public key, the public key and the private key being associated with the at least one payment instrument;
incorporate the public key into the digital certificate; and
transmit the private key to a user device associated with the user.

2. The system according to claim 1, wherein the at least one digital certificate is digitally signed using a digital signature by a notary.

3. The system according to claim 2, wherein the at least one digital certificate includes a further public key associated with the notary.

4. The system according to claim 1, wherein the computer server is configured to store the at least one digital certificate in a centralized computer database.

5. The system according to claim 1, wherein the computer server is configured to receive a transaction request digitally signed using a digital signature, the transaction request being associated with the at least one payment instrument, the transaction request including the at least one digital certificate, and the digital signature being generated by the user using the private key associated with the at least one payment instrument.

6. The system according to claim 5, wherein the computer server is configured to:
verify the at least one digital certificate included in the transaction request;
authenticate the user by decrypting the digital signature using the public key associated with the at least one payment instrument; and
determine an ownership of the at least one payment instrument to be the user.

7. The system according to claim 6, wherein verify the at least one digital certificate included in the transaction request includes decrypting a further digital signature signing the digital certificate by a further public key of an authority issuing the digital certificate, the further digital signature signing the digital certificate being generated using a private key of the authority issuing the digital certificate.

8. The system according to claim 1, wherein the at least one payment instrument include a plurality of payment instruments administered by one entity.

9. The system according to claim 1, wherein the at least one digital certificate include a plurality of digital certificates signed by different authorities.

10. The system according to claim 1, wherein the at least one payment instrument is a virtual payment instrument.

11. The system according to claim 1, wherein the computer server is further configured to store on the at least one payment instrument the public key associated with the at least one payment instrument and a digital signature generated using the private key associated with the at least one payment instrument.

12. A method of managing universal identification-based payment instruments, comprising:
receiving at least one digital certificate as an universal identification) of a user;
associating the at least one digital certificate with at least one payment instrument of the user;
generating a public key and a private key pairing with the public key, the public key and the private key being associated with the at least one payment instrument;
incorporating the public key into the digital certificate; and
transmitting the private key to a user device associated with the user.

13. The method according to claim 12, wherein the at least one digital certificate is digitally signed using a digital signature by a financial institution.

14. The method according to claim 13, wherein the at least one digital certificate includes a further public key associated with the financial institution and used to verify the digital signature.

15. The method according to claim 12, further comprising storing the at least one digital certificate in a decentralized computer database.

16. The method according to claim 12, wherein the at least one digital certificate is digitally signed using a digital signature by a department of vehicle.

17. The method according to claim 16, wherein the at least one digital certificate includes a further public key used to verify the digital signature.

18. The method according to claim 12, wherein the at least one digital certificate is digitally signed using a digital signature by a notary.

19. The method according to claim 18, wherein the at least one digital certificate includes a further public key associated with the notary and used to verify the digital signature.

20. A non-transitory, computer-readable medium comprising instructions for managing universal identification-based payment instruments that, when executed on a computer arrangement, cause the computer arrangement to perform procedures comprising:
receiving at least one digital certificate as an universal identification of a user;
associating the at least one digital certificate with at least one payment instrument of the user;
generating a public key and a private key pairing with the public key, the public key and the private key being associated with the at least one payment instrument;
incorporating the public key into the digital certificate; and
transmitting the private key to a user device associated with the user.
